(19) United States
(12) Patent Application Publication
(10) Pub. No.: US 2008/0291042 A1
(43) Pub. Date: Nov. 27, 2008

(54) INERTIAL MEASUREMENT UNIT LOCALIZATION TECHNIQUE FOR SENSOR NETWORKS

(75) Inventor: Richard Pereira Soares, Jr., Clearwater, FL (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/752,357

(22) Filed: May 23, 2007

(51) Int. Cl. G08B 21/00

(52) U.S. Cl. 340/686.1

(57) ABSTRACT

A sensor node for a wireless sensor network is provided. The sensor node comprises a sensor module including one or more sensors, a data processor in operative communication with the sensor module, a radio frequency transceiver in operative communication with the data processor, and an inertial measurement unit in operative communication with the radio frequency transceiver. A power source is coupled to the sensor module, the data processor, the radio frequency transceiver, and the inertial measurement unit. The inertial measurement unit is configured to determine a location of the sensor node during initial deployment of the sensor node in the sensor network.

### BACKGROUND

Determining the location of sensor nodes deployed in sensor networks is a major issue facing network designers. A variety of solutions have been suggested, such as techniques that are based on negotiation schemes between nearby sensor nodes and sink nodes, Global Positioning System (GPS) receivers, and the use of beacons to name just a few. These techniques, however, present their own difficulties. For example, GPS receivers have many problems inherent to communication systems such as interference, fading, and multi-path. In addition, GPS receivers cannot operate in enclosed places or where obstructed from a clear line-of-sight to GPS satellites.

The location of sensor nodes must be known so that position and velocity data from vibration or other signals coming from potential targets can be determined in relation to these sensor nodes. This data is usually transmitted to a processing node for signal analysis and target identification. Proposed smart sensors could perform all the signal processing and target identification at the sensor nodes. Due to power consumption restraints for battery-operated sensor nodes, this design scheme has not been fully developed. In any case, no matter what system configuration is used for sensor nodes in a sensor network, the three-dimensional location of the sensor node must be determined so that the three-dimensional position and velocity of a potential target can be determined.

### SUMMARY

The present invention is directed to a sensor node for a wireless sensor network. The sensor node comprises a sensor module including one or more sensors, a data processor in operative communication with the sensor module, a radio frequency transceiver in operative communication with the data processor, and an inertial measurement unit in operative communication with the radio frequency transceiver. A power source is coupled to the sensor module, the data processor, the radio frequency transceiver, and the inertial measurement unit. The inertial measurement unit is configured to determine a location of the sensor node during initial deployment of the sensor node in the sensor network.

### BRIEF DESCRIPTION OF THE DRAWINGS

Features of the present invention will become apparent to those skilled in the art from the following description with reference to the drawings. Understanding that the drawings depict only typical embodiments of the invention and are not therefore to be considered limiting in scope, the invention will be described with additional specificity and detail through the use of the accompanying drawings, in which:

FIG. 1 illustrates a schematic configuration of a sensor network;

FIG. 2 is a block diagram of a sensor node that can be part of the sensor network of FIG. 1; and

FIG. 3 is a block diagram of a sensor node with an inertial measurement unit that can be part of the sensor network of FIG. 1.

### DETAILED DESCRIPTION

In the following detailed description, embodiments are described in sufficient detail to enable those skilled in the art to practice the invention. It is to be understood that other embodiments may be utilized without departing from the scope of the present invention. The following detailed description is, therefore, not to be taken in a limiting sense.

The present invention is directed to an inertial measurement unit localization technique for sensor networks. In this technique, an inertial measurement unit (IMU) is employed in one to N (one or more) sensor nodes to determine a location of the sensor nodes during initial deployment of a sensor network. The sensor node IMU operates while the sensor node is moving to its final destination, constantly tracking position. The rest of the sensor node electronics are not required to be activated until the sensor node has reached its final destination.

The present IMU-based sensor nodes can be used in any sensor network. In one implementation, sensor nodes are used in sensor networks that do not move after initial deployment. The present sensor nodes can be employed without power-hungry GPS receivers to determine location, since the GPS is typically used to determine the location of systems that move. The IMU-based sensor nodes can operate anywhere, e.g., under water, on land, in caves, and even on the moon or other planets, because the IMU tracks all movements from an initial known starting point. A sensor node with a completely internal IMU is a preferred configuration in most applications.

The benefits of the present IMU-based approach are simplicity, low power consumption, and low cost. In addition, there are no complicated algorithms to implement and take up processing time in the sensor node. The IMU operates only during initial deployment thereby reducing overall power consumption, which is important for battery-operated systems.

Further details of the present invention are discussed hereafter with respect to the Figures.

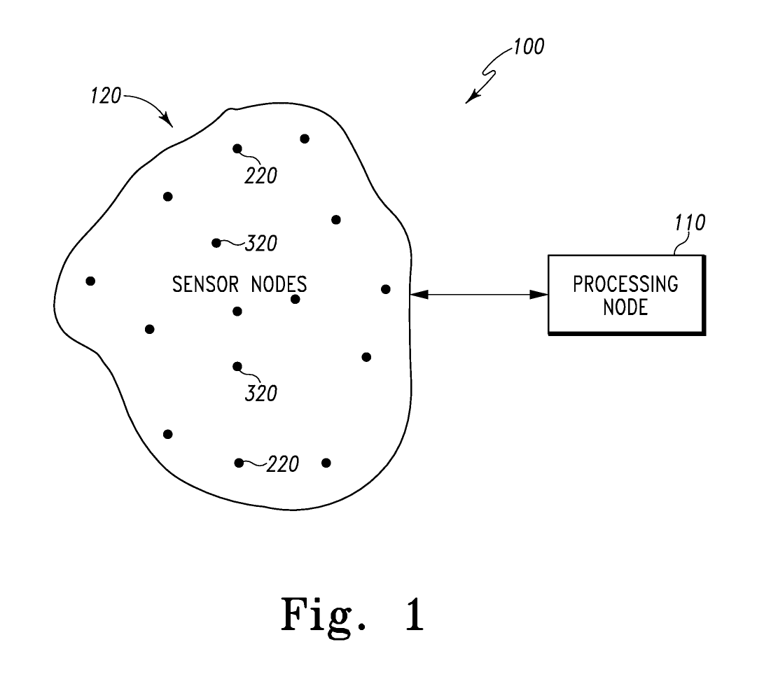

FIG. 1 is a schematic configuration of a wireless sensor network 100 that includes a processing node 110 and a plurality of sensor nodes 120. The processing node 110 includes a computer such as a conventional personal computer (PC), programmable logic device, mainframe computer, or the like. The computer is connected to a wireless communication device. The processing node 110 acts as the end user interface for sensor network 100, and is loaded with the necessary software for controlling sensor network 100. The processing node 110 allows for prioritization of tasks in response to a real-time set of events, allows for easy expansion and contraction of an existing network of sensors, and provides control of distributed processes.

In a typical application, the sensor network 100 may contain any suitable number of sensor nodes, such as up to hundreds or even thousands of sensor nodes. The sensor nodes can be randomly positioned by aircraft drops, artillery shells, ship drops, or by any other viable deployment mechanism, such as by hand. For example, the sensor nodes can be dropped by an individual walking or can be thrown from a ground vehicle as long as some way of determining the drop reference point is available. The sensor nodes for a given application may be identical or may have varying sensor, computational, or transceiver capabilities.

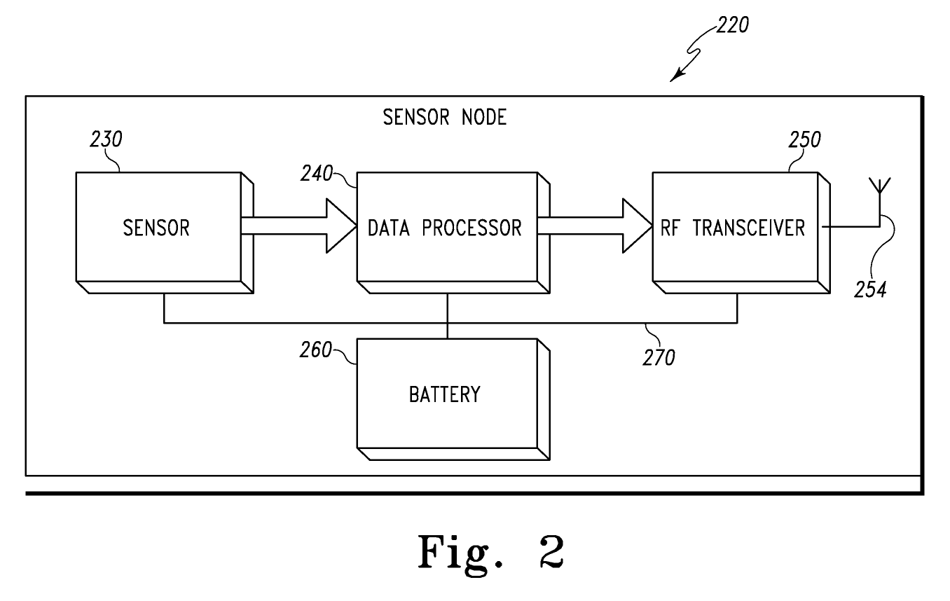

FIG. 2 is a block diagram representation of a sensor node 220 that can be part of a wireless network such as sensor network 100. The sensor node 220 includes a sensor module 230 that is in operative communication with a data processor 240, which in turn is in operative communication with a radio frequency (RF) transceiver 250. One or more antennas 254 are coupled to RF transceiver 250. A power source 260 such as one or more batteries is coupled to sensor module 230, data processor 240, and RF transceiver 250 through a power bus 270.

The sensor module 230 can include one or more sensors that provide detection and analysis of a physical condition to be monitored over a given area. Such physical conditions can include vibration, infrared radiation, sound, temperature, pressure, and the like. Exemplary sensors that can be employed in sensor module 230 include vibration sensors such as a piezoelectric cable or an accelerometer to detect vibrations, a differential pressure sensor, temperature sensors, a magnetometer, acoustic sensors, optical sensors, or various combinations of the foregoing sensors. When a piezoelectric cable is employed, vibrations on the ground and above ground can be detected by the sensor.

The data processor 240 can be a microprocessor, a microcontroller, a digital signal processor, a central processing unit (CPU), a programmable logic device, a computer, or the like. The data processor 240 generally provides control of all software tasking for sensor node 230, and also supports peripheral hardware control. The data processor 240 also provides computational power for calibration of the sensors and for signal processing. The data processor 240 acquires analog data from the sensors and converts the analog sensor signals to digital signals for transmission by RF transceiver 250. The data processor 240 also controls RF transceiver 250 and power source 260.

The RF transceiver 250 can be configured to transmit, receive, modulate, and encrypt signals within the sensor network through the one or more antennas 254. Encryption provides security of transmitted data so only the intended recipients are able to read the data. The RF transceiver can provide for communicating with other sensor nodes and the processing node within the sensor network, as well as other communication devices such as satellites, cellular or microwave towers, or any other communication device as necessary. When multiple antennas are employed, separate transmit and receive antennas can be used, or multiple antenna systems or arrays can be used to provide antenna diversity or beam forming.

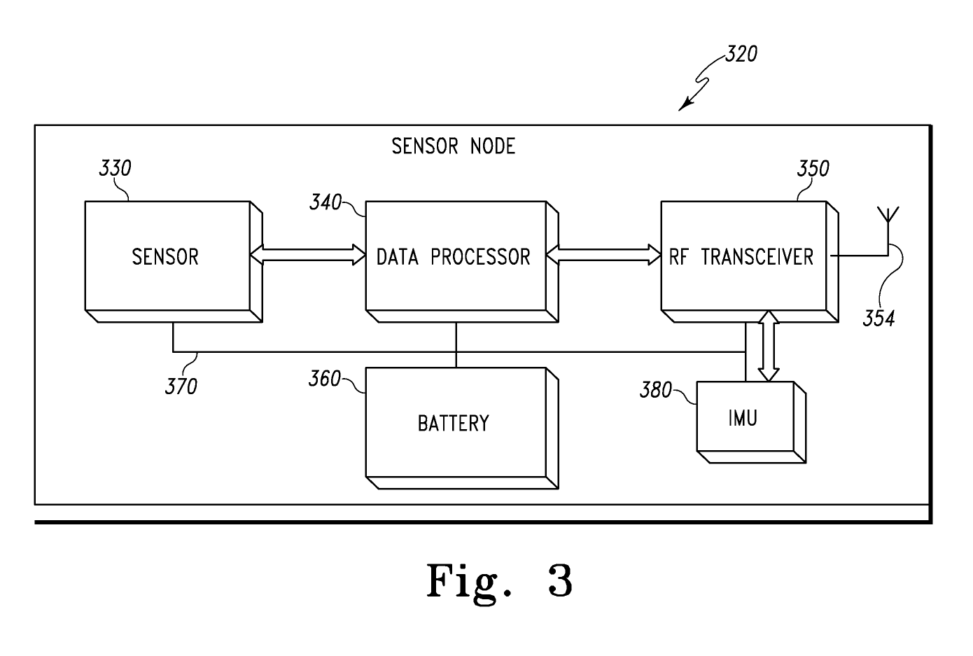

FIG. 3 depicts a sensor node 320 according to another embodiment. The sensor node 320 can be part of a sensor network, such as sensor network 100 shown in FIG. 1. The sensor node 320 includes a sensor module 330 that is in operative communication with a data processor 340, which in turn is in operative communication with an RF transceiver 350. An antenna 354 is coupled to RF transceiver 350. A power source 360 such as one or more batteries is coupled to sensor module 330, data processor 340, and RF transceiver 350 through a power bus 370. Each of these components of sensor node 320 can be similar to or the same as the corresponding components discussed previously with respect to sensor node 220.

The sensor node 320 further includes an inertial measurement unit (IMU) 380 in operative communication with RF transceiver 350. The IMU 380 generally includes embedded instrumentation such as one or more gyroscopes, angular accelerometers, velocity meters, or other inertial sensors. The IMU 380 communicates positional data to RF transceiver 350 for transmission to a processing node or other sensors in the sensor network. The IMU 380 can be configured to operate only during deployment of sensor node 320 to save power.

The IMU is a closed system that can detect altitude, location, and motion. Typically, the IMU detects the current acceleration rate and rate of change in attitude (i.e., pitch, roll and yaw rates) and then sums these rates to find the total change from the initial position. The data provided by the IMU is all that is needed to perform dead reckoning of the current position of a sensor node.

In one implementation, the IMU can include an enclosure containing three accelerometers and three gyroscopes. The accelerometers are placed in the enclosure such that their measuring axes are orthogonal to each other, and measure the so-called “specific forces” (inertial acceleration−gravity). The gyroscopes are also placed in the enclosure such that their measuring axes are orthogonal to each other, and measure rotation rates. One or more temperature sensors can be included in the IMU, such as by being incorporated in each accelerometer or gyroscope, or as additional sensors to calibrate raw data from the other sensors in the sensor node.

To achieve enhanced accuracy, the enclosure of the IMU may be designed such that the temperature is controlled and kept constant. The walls of the enclosure can be made of materials that minimize electromagnetic interference.

Referring again to FIG. 1, sensor network 100 can include both sensor nodes 220 (without IMUs) and sensor nodes 320 (with IMUs) deployed in various locations and in operative communication with processing node 110. In alternative implementations, network 100 can include only sensor nodes 320; or groupings of sensor nodes 220 that communicate with respective sensor nodes 320 for location determination can be deployed.

In a method for deployment of sensor network 100, a plurality of sensor nodes can be deployed from one or more starting locations. The IMUs in sensor nodes 320 are initialized based on the one or more starting locations. Each IMU tracks the movement of a respective sensor node 320 that carries the IMU until the sensor node reaches a resting location. The IMU sends tracking data to the RF transceiver of the sensor node, which transmits the tracking data to processing node 110. A position of the resting location of the sensor node is then determined. The processing node 110 can be configured to transmit a power-up signal to the deployed sensor nodes to have the other electronic components of the sensor nodes power-up.

While most sensor nodes will not move after initial deployment, a re-initialization scheme can be employed to determine the location of sensor nodes that move. For example, if a sensor node 320 moves from its initial resting location, the IMU therein can be powered up again to track the movement of the sensor node from the resting location to a new location. The position of the new location of sensor node 320 can then be determined from the tracking data and the resting location.

When groupings of sensor nodes 220 and a respective sensor node 320 are deployed together, the sensor nodes 220 and 320 can be configured to communicate with each other to determine the location of sensor nodes 220 on the ground.

Instructions for carrying out various process tasks, calculations, and generation of signals and other data used in the operation of the sensor nodes and network described herein can be implemented in software, firmware, or other computer readable instructions. These instructions are typically stored on any appropriate computer readable medium used for storage of computer readable instructions or data structures. Such computer readable media can be any available media that can be accessed by a general purpose or special purpose computer or processor, or any programmable logic device.

Suitable computer readable media may comprise, for example, non-volatile memory devices including semiconductor memory devices such as EPROM, EEPROM, or flash memory devices; magnetic disks such as internal hard disks or removable disks; magneto-optical disks; CDs, DVDs, or other optical storage disks; nonvolatile ROM, RAM, and other like media; or any other media that can be used to carry or store desired program code means in the form of computer executable instructions or data structures. Any of the foregoing may be supplemented by, or incorporated in, specially-designed application-specific integrated circuits (ASICs), or field programmable gate arrays (FPGAs). When information is transferred or provided over a network or another communications connection (either hardwired, wireless, or a combination of hardwired or wireless) to a computer, the computer properly views the connection as a computer readable medium. Thus, any such connection is properly termed a computer readable medium. Combinations of the above are also included within the scope of computer readable media.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A sensor node comprising:
a sensor module including one or more sensors;
a data processor in operative communication with the sensor module;
a radio frequency transceiver in operative communication with the data processor;
an inertial measurement unit in operative communication with the radio frequency transceiver; and
a power source coupled to the sensor module, the data processor, the radio frequency transceiver, and the inertial measurement unit;
wherein the inertial measurement unit is configured to determine a location of the sensor node during initial deployment of the sensor node in a sensor network.

2. The sensor node of claim 1, wherein each of the sensor module, the data processor, the radio frequency transceiver, and the inertial measurement unit are coupled to the power source by a power bus.

3. The sensor node of claim 1, wherein the one or more sensors comprise a vibration sensor, a differential pressure sensor, a temperature sensor, a magnetometer, an acoustic sensor, an optical sensor, or combinations thereof.

4. The sensor node of claim 3, wherein the vibration sensor comprises a piezoelectric cable.

5. The sensor node of claim 1, wherein the data processor comprises a microprocessor, a microcontroller, a digital signal processor, a central processing unit, a programmable logic device, or a computer.

6. The sensor node of claim 1, wherein the power source comprises one or more batteries.

7. The sensor node of claim 1, wherein the inertial measurement unit comprises one or more gyroscopes, angular accelerometers, velocity meters, or combinations thereof.

8. A wireless sensor network comprising:
a plurality of sensor nodes, each of the sensor nodes comprising:
a sensor module including one or more sensors;
a data processor in operative communication with the sensor module;
a radio frequency transceiver in operative communication with the data processor; and
a power source coupled to the sensor module, the data processor, and the radio frequency transceiver;
wherein one or more of the sensor nodes further comprises an inertial measurement unit in operative communication with the radio frequency transceiver and coupled to the power source; and
a processing node in operative communication with the plurality of sensor nodes;
wherein the inertial measurement unit is configured to determine a location of a sensor node that includes the inertial measurement unit during initial deployment of the sensor node in the sensor network.

9. The sensor network of claim 8, wherein the one or more sensors comprise a vibration sensor, a differential pressure sensor, a temperature sensor, a magnetometer, an acoustic sensor, an optical sensor, or combinations thereof.

10. The sensor network of claim 9, wherein the vibration sensor comprises a piezoelectric cable.

11. The sensor network of claim 8, wherein the radio frequency transceiver is configured to communicate with other sensor nodes and the processing node in the sensor network.

12. The sensor network of claim 8, wherein the inertial measurement unit is configured to communicate positional data to the radio frequency transceiver for transmission to the processing node in the sensor network.

13. The sensor network of claim 8, wherein the processing node comprises a computer and a wireless communication device.

14. The sensor network of claim 8, wherein one or more of the sensor nodes lack an inertial measurement unit.

15. The sensor network of claim 14, wherein the sensor nodes that lack an inertial measurement unit are configured to communicate with one or more sensor nodes that include an inertial measurement unit.

16. A method for deployment of a wireless sensor network, the method comprising:
providing a processing node;
providing a plurality of sensor nodes, each of the sensor nodes comprising:
a sensor module including one or more sensors;
a data processor in operative communication with the sensor module;
a radio frequency transceiver in operative communication with the data processor; and
a power source coupled to the sensor module, the data processor, and the radio frequency transceiver;
wherein one or more of the sensor nodes further comprises an inertial measurement unit in operative communication with the radio frequency transceiver and coupled to the power source;
deploying the plurality of sensor nodes from one or more starting locations;
initializing the inertial measurement unit based on the one or more starting locations;
employing the inertial measurement unit to track movement of the sensor node that carries the inertial measurement unit until the sensor node reaches a resting location;
transmitting tracking data from the sensor node to the processing node; and
determining a position of the resting location of the sensor node.

17. The method of claim 16, wherein one or more of the sensor nodes lack an inertial measurement unit.

18. The method of claim 17, wherein the sensor nodes that lack an inertial measurement unit are configured to communicate with one or more sensor nodes that include an inertial measurement unit.

19. The method of claim 16, further comprising transmitting a power-up signal from the processing node to the deployed sensor nodes so that other electronic components of the sensor nodes power-up.

20. The method of claim 16, further comprising:
employing the inertial measurement unit to track movement of a sensor node that has moved from the resting location to a new location; and
determining the position of the new location from tracking data and the resting location.
